(19) United States
(12) Patent Application Publication
(10) Pub. No.: US 2025/0245560 A1
(43) Pub. Date: Jul. 31, 2025

(54) DRIVER VARIABLE SENSITIVITY USING TENSORFLOW RESIDUALS

(71) Applicant: INTUIT INC., Mountain View, CA (US)

(72) Inventors: Aniruddha BARDHAN, Bangalore (IN); Avinash PASUPULATE, Bangalore (IN); Sidharth KUMAR, Chennai (IN)

(21) Appl. No.: 18/428,539

(22) Filed: Jan. 31, 2024

(51) Int. Cl. G06N 20/00

(52) U.S. Cl. CPC G06N 20/00

(57) ABSTRACT

Certain aspects of the present disclosure provide techniques for determining sensitivities of result variables to driver variables of a system. Various systems can be represented by a directed acyclic graph representation using nodes and edges to represent entities and relationships. A residual at the nodes can be determined to isolate the effect of a particular node on downstream nodes from the effect of upstream nodes on the particular node. High sensitivities to features associated with the system can be determined by weights that are components of a hyperparameter value resulting from optimizing an algorithmic sum of a loss function and the hyperparameter. Sensitivities to features can be used to present or prevent intervention using sensitive features.

### INTRODUCTION

Aspects of the present disclosure relate to determining sensitivities of driver variables to user actions using residuals of tensorflow models representing causal relationships among driver variables related to the user actions.

### BACKGROUND

In various contexts, graph representations of entities may be used to represent various types of entities and various relationships using nodes corresponding to entities and edges corresponding to the relationships. In some cases, graphs may be representations of causal networks having many parameters. When a graph has many elements it may be difficult or impossible to infer proportional causality of entities due to the number and complexity of the causal relationships, particularly where multiple confounders are present or where complicated feedback loops exist.

Thus, although causal systems may be represented graphically, sensitivity of a particular result to another element of the system may be indeterminable using traditional methods. Examples where a sensitivity of a result to a variable is confounded by other factors include situations involving a customer sensitivity to price or a patient sensitivity to a pharmaceutical dosage. In various cases, individual sensitivity to price or dosage can be confounded by any number of factors which makes it impossible to determine an optimal dosage or price point using traditional methods. Mispricing can cause potential customers to miss out on discount offers and/or can cause companies to lose profits. Misdosing can result in ineffectual treatment, wasted resources due to excessive intervention, or unwanted side effects due to overdosing. In various situations, lack of information about sensitivity of a result to a driver variable can cause many other problems.

In a causal graph representation, entities may be upstream or downstream from one another in a chain of causation. One particular challenge present in causal inferencing is determining the relative causational contribution from multiple upstream causes that are all upstream of a downstream effect. This problem makes it difficult to determine which factors are causing a particular result. Thus, it may be often impossible to determine what factors produce a particular result and/or impossible to optimize a set of parameters to maximize a likelihood of a particular result using traditional techniques. Even when applying machine learning techniques, determining the independent effect on a result caused by a selected variable may be impossible for inter-correlated systems of variables. Furthermore, even if a result is highly sensitive to a parameter, such a parameter may be difficult or impossible to identify using traditional methods.

Accordingly, techniques are needed that improve predictions of cause and effect for causal networks and/or their graph representations, even in the presence of confounders. Techniques are further needed that enable identification of features of a model of a causal network to which a result is sensitive. Techniques are also needed to accurately determine driver variables for which an optimized value may maximize a result.

### BRIEF SUMMARY

Certain embodiments herein provide a computer-implemented method for determining sensitivities of driver variables to user actions using residuals of tensorflow models representing causal relationships among driver variables related to the user actions. In various embodiments, methods disclosed herein comprise: A method of using machine learning to automatically predict sensitivity of results to features, comprising: receiving a tensorflow model of a first node, a second node, and a third node downstream from the second node; negating a first output of the second node determined using an initial output of the first node and an initial weight associated with the second node; generating a second output of the second node based on the negated first output and a set of input parameters used as input for the second node; minimizing a value based on a machine learning loss function for the third node to determine a parameter and an updated weight for the second node as a component of the parameter; and determining a sensitivity of a variable represented by the third node to a feature of the second node based on the updated weight and a threshold.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 illustrates an example computing environment in which sensitivities of driver variables to user actions using residuals of tensorflow models may be determined, according to various embodiments of the present disclosure.

FIG. 2 illustrates an example system architecture in which sensitivities of driver variables to user actions using residuals of tensorflow models are determined, according to various embodiments of the present disclosure.

FIG. 3 illustrates an example causal DAG in which a sensitivity of a result variable to a feature of a driver variable is determined, according to various embodiments of the present disclosure.

FIG. 4 illustrates an example method for determining sensitivities of result variables of a tensorflow model, according to various embodiments of the present disclosure.

FIG. 5 illustrates an example system configured for determining sensitivities of result variables to driver variable features, according to various embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

According to embodiments described herein, causal inference is used to determine values for “driver variables” in a causal network that yield a particular result for certain parameters. In this context, driver variables are variables which have a causational interrelationship with each other. The driver variables may be considered driver variables for a particular result. For example, many driver variables can influence whether a state change occurs, or would be more likely to occur, within a framework or platform. Examples of state changes include changes in an account state due to account creation or upgrade, change of privilege level, change in access to content, change in ownership of a product, change in upgrade level of a product, change in a pharmaceutical dosage or other change in medical or therapeutic intervention. In general a state change may refer to any change of state in a user environment. By determining driver variables that a result is sensitive to, changes to driver variables can be made selectively based on sensitivity. For example, changes in a price or dosage can be selectively performed based on a determination that the changes are likely to cause or prevent a particular result (e.g. a customer purchase or upgrade, customer retention, customer churn, a therapeutic effect for a patient, a patient side effect, etc.). Identifying sensitivities of results to a driver variable may be useful in various contexts, such as to determine an optimal product and price portfolio offer, to determine an optimal pharmaceutical intervention dosage treatment schedule, or in other situations.

Sensitivities of a result of a causal network to individual parameters of the network can be determined in isolation from upstream causal factors by determining parameter sensitivities based on weights which are assigned to the parameters at nodes of a model of the network and which are refined based on updating a loss function and nodal residuals for parameter weights of the model. In certain embodiments, tensorflow residuals are used to make accurate inferences about sensitivity of a result variable to various other variables (e.g., driver variables) or features of variables, such as sensitivity of user purchase or upgrade to price, sensitivity of a pharmaceutical intervention to a user change in dosage, or other systems. In such or similar complicated systems, there may be a set of variables that are driver variables of the system.

Various embodiments described herein allow for identifying a feature of a model that represents a driver variable to which a result is highly sensitive. For example, such a feature may be identified based on determining that a weight for the feature is above a threshold after imposing, on a deep learning framework used to teach the model, a particular constraint. The constraint may include feature weights as a component of the constraint and may be defined using an arithmetic combination of a loss function for a driver variable and residuals of nodes of the model. In situations, a particular result variable may be highly sensitive to a feature or features representing one or more driver variables of a system described by a causal graph. However, determining features representing driver variables to which the result variable is highly sensitive may be difficult or impossible using traditional techniques. In some cases, a result variable may be a result variable for a driver variable which is represented by a feature that is adjustable or controllable. For example, a price of a product is a controllable feature for which purchase, upgrade, churn, etc., may be a result variable in a causal model. Similarly, a dosage for a pharmaceutical intervention is a controllable feature for which a desired therapeutic effect is a result variable (e.g. a target blood pressure, a target insulin level, etc.). However, determining controllable features and values of features representing other driver variables to which the result variable is highly sensitive may be difficult or impossible using traditional techniques.

To continue the example, in the case that the controllable feature representing a driver variable is a price of a product, features may be determined for which change in user state (e.g. purchase, upgrade, downgrade, churn, etc.) will be highly sensitive to the controllable driver variable (price). Any combination of data set features, such as but not limited to the features of the example data set features described herein, for which a result variable is highly sensitive to price can be identified. For example, users who engage with a certain feature may be identified as price sensitive. Also, users having certain demographic or geographic attributes may be identified as price sensitive. In this way, changes in prices can be based on a sensitivity determined by features data (e.g., features other than the driver variable, such as price), so price changes may be custom to a user and selective and/or based on other features of the system.

In another example, the driver variable may be a controllable dosage, and the result variable may be a particular therapeutic effect or biological response. In this case, users having certain medical histories or biological attributes may be identified as dosage sensitive, enabling more accurate dosaging and avoidance of misdosing. For a particular driver variable or feature of a driver variable which may be controllable or adjustable, various features may be determined for which a particular result variable will be highly sensitive to the controllable driver variable. Thus, any combination of values for data set features may be identified for which a result variable (e.g. state change) may be highly sensitive to a particular driver variable or feature (e.g. price or dosage), and changes to the particular driver variable may be made based on the determined sensitivities.

In embodiments, a TensorFlow deep learning framework is used to generate a model of a causal network. In such embodiments, a tensorflow library, (such as PyTorch or TensorFlow for Python) facilitates efficient numerical computing and mathematical operations. Such high-level libraries may be used to develop machine learning and deep learning models. In this context, a variable is a state or value for a node that can be modified by performing tensorflow operations on the variable. Variables may be made using a constructor that takes input parameters for the variable. The input parameters are used to generate a tensor that can be of any shape corresponding to the input parameters. In this way, nodes can be constructed to receive input from other nodes, as well as receive other input parameters, and generate results for downstream nodes.

In general, a loss function for a model may refer to a function that is defined at least in part by a difference between a predicted or theoretical value of a model and an actual result or value output by the model. As used herein a loss function or machine learning loss function may refer to a loss function for a deep learning framework used to implement a neural network or deep neural network. In particular embodiments, a TensorFlow deep learning framework is used. In such embodiments, a tensorflow library, (such as PyTorch or TensorFlow for Python) facilitates efficient numerical computing and mathematical operations. Such high-level libraries may be used to develop machine learning and deep learning models. In this context, a variable is a state or value for a node that can be modified by performing tensorflow operations on it. Variables may be made using a constructor which takes input parameters for the variable. The input parameters are used to generate a tensor that can be of any shape corresponding to the input parameters. In this way, nodes can be constructed to receive input from other nodes, as well as receive other input parameters, and generate results for downstream nodes.

A universe of features of a system may be grouped or sorted into categories associated with different variables. The variables are represented by nodes of a tensorflow model. Input parameters for features associated with the variables are provided at nodes to define the variables. Each of the variables can have multiple features associated with the variable. The variables may include driver variables for a result variable, such as the driver variables that tend to influence a downstream result variable. The relationship may be correlational, and the correlation may be complex and not necessarily directly causational.

One example in which various driver variables may be represented as a directed acyclic graph (“DAG”) is a model of demand elasticity based on various driver variables. In this case, traditional techniques determine demand and price independently using confounders and regression of the independent determinations. However since a causal graph or DAG can be highly complex with no limit to the number of interactions between confounder variables, traditional methods fail to accurately determine perturbation effects on the system.

To overcome such difficulties, effects of variables that occur upstream to a particular node of a Causal DAG are refined from calculations by solving node weights based on constraints on correlations between nodal residuals in the causal graph. In this way, causal graphs can be used to individually model propensities for various actions to yield a target action. Modelling propensities enables accurate perturbation magnitudes between a driver variable and/or feature of a driver variable and a target action to be identified. Using input parameters separately input at different nodes which represent the different driver variables, imposing constraints, and determining and feeding residuals forward downstream in the graph, a self-consistent weighting for the causal DAG can be determined by optimizing a weight-based hyperparameter which provides an accurate and correct weighting (e.g. sensitivity) once determined.

One example constraint may be imposing that the sum of the absolute values of the residuals and the pairwise sum of absolute correlations between nodal residuals should sum to zero. Such a constraint may be imposed as a soft margin constraint and summed with a loss function for a hyperparameter which is determined using weights for different nodes as components of the hyperparameter, such as by computing a sum (or absolute value sum) of the weights. The weights of the components of the hyperparameter that minimizes the resultant overall validation loss can be determined. Thus, it may be determined which driver variable or feature causes the greatest perturbation by that variable or feature having the greatest weight determined as a component of the hyperparameter.

Applying this concept, to the example of price elasticity, a user sensitivity to price elasticity can be determined by a high perturbation magnitude between a price of a product or products for the user and a state change such as purchase or upgrade of the product or products by the user. In the example of medical intervention, a sensitivity to dosage change may be determined by isolating driver variables that are upstream from a driver variable representing a dosage change for an intervention or intervention cycle. In such example, different states for a user can refer to different tiers of a platform (i.e. trial, start tier, essentials ties, plus tier, premium tier, elite tier, advanced tiers, feature activation, etc.), or different intervention plans (daily, weekly, conservative, normal, aggressive, low-dosage, medium-dosage, high-dosage, etc.). A model may be used to simultaneously predict all the states for each user at the end of every month or the beginning of the next month, so that appropriate action (upgrade/downgrade/attach to Payroll, T-Sheets/Discounting) can be taken based on pricing to keep the user engaged with the an ecosystem for as long as possible. Various uses cases can include: Use case 1: Price Sensitivity for Retention—Cancellation Saves of SKUs; Use case 2: Price Sensitivity for Upgraders to Advanced and Plus; Use case 3: Price Sensitivity for Upgraders for product SKUs CORE, PREMIUM, ELITE; Use case 4: Price Sensitivity for feature upgrades.

In certain cases, there may be a high perturbation magnitude between price and state change for certain features of a system. For example, users who have used certain component features of an application or for which user attributes or features are shown to result in a higher sensitivity to price changes may be selected for a discounted price offer based on the determined sensitivity. In a particular embodiment, the discounted offer may be a discount on a selection of products determined according to an application use history associated with a user, account, or device, such as a user accessing an account of an application server hosting the applications via a client device.

In another example, there may be a high perturbation magnitude between dosages or intervention and state change for certain features of a system. In a situation where there may be complex interactions between medications, a change in dosage may be determined based on a high sensitivity. This may allow a desired effect to be achieved with as little intervention as possible, and/or may allow combinations with high sensitivities that are potentially dangerous to be avoided.

The sensitivities of state changes or other driver variables to various features of the system can be used to determine metrics for the features. For example, weightings based on features of a user, such as interventions, or use of features in a computing environment, may be used to determine whether a threshold sensitivity is met. In this way, changes can be selectively presented in cases where it is determined that there is a perturbation magnitude above a certain threshold. The sensitivity threshold can be defined by a scale from not sensitive to maximally sensitive. A threshold can be based on whether the determined sensitivity is greater than a percentage to the maximum sensitivity, such as 50% of the maximum or 75% of the maximum being used as a threshold to determine high sensitivity. A threshold of sensitivity may also be defined relative to average sensitivity, such as being above an average or a certain amount above an average (such as a median or mean perturbation magnitude, or one or more standard deviations above a median or mean perturbation magnitude). In some cases, where a limited number of promotional discounts are available, a limited number of the most price sensitive users of a system may be identified and offered the limited number of price discounts, reducing the number of wasted offers and the waste of resources used to generate wasted offers. Continuing the example of price sensitivities, in cases where multiple products are available to a user, these metrics and/or perturbation magnitudes may be used to determine an optimal product portfolio of the multiple products and/or an optimal bundle price for the portfolio. Regardless, a threshold may be set anywhere from near zero to near 100%.

Embodiments of the present disclosure provide multiple technical improvements with respect to conventional techniques for automatically determining causal relationships among variables represented in electronic data. For example, existing techniques for modeling data in causal graphs are unable to infer proportional causality of entities due to the number and complexity of the causal relationships, particularly where multiple confounders are present or where complicated feedback loops exist. However, by modeling such data in a tensorflow causal graph and using a machine learning framework (e.g., a deep learning framework) to solve node weights based on constraints on correlations between nodal residuals in the causal graph, embodiments of the present disclosure individually model propensities for various actions to yield a target action, and thereby allow causal relationships to be accurately identified in a way that could not be done using conventional techniques. Existing machine learning techniques are unable to determine the independent effect on a result caused by a selected variable for inter-correlated systems of variables, while techniques described herein allow such a determination to be made through the use of a particular deep learning process by which a weight-based hyperparameter is optimized to provide an accurate and correct weighting (e.g. sensitivity). As such, embodiments of the present disclosure may allow automated determinations to be made based on automatic causal determinations with a higher level of accuracy, such as selecting targeted content to provide to users via software applications that is most likely to result in a particular user action. Furthermore, techniques described herein avoid computing resource utilization that would otherwise occur in connection with generating and processing inaccurate causal determinations, such as providing irrelevant or unhelpful content to users or otherwise performing actions based on such causal determinations.

### Example Computing Environment for Determining a Sensitivity of a Driver Variable

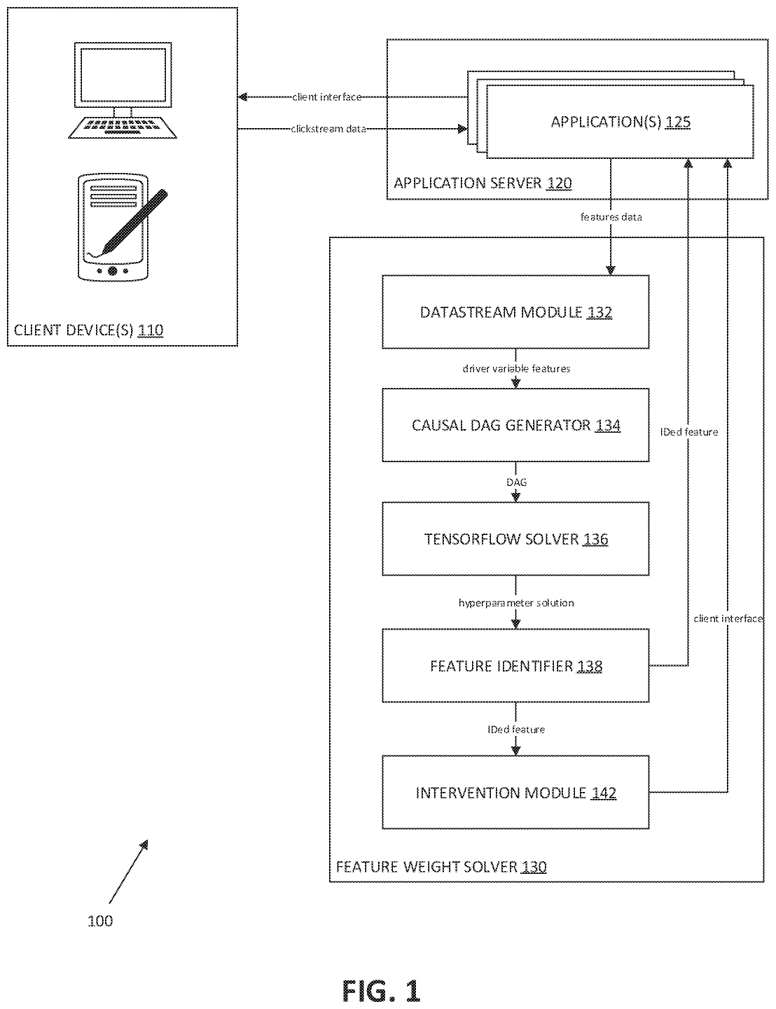

FIG. 1 illustrates an example computing environment 100 in which sensitivities of state changes to features may be determined. In embodiments, various features included in features data are input as parameters into nodes of tensorflow models and sensitivities to the features are determined using residuals of the tensorflow models. In this way, features may be identified by weights of hyperparameters of the tensorflow models indicating sensitivities to the features.

In FIG. 1, one or more client devices 110 are connected to an application server 120 to access one or more applications 125. Client data (including user input, clickstream, and/or other client or user data) is received by the application server 125.

The client data and features data associated with the applications are sent from the application server 120 to the feature identifier 130. In various embodiments, the feature identifier detects features by determining that a hyperparameter has a high weight associated with the feature.

In the example, the sensitivity detector 130 includes a datastream module 132, a causal DAG generator 134, a tensorflow solver 135, a feature identifier 136, and a client intervention module 138. The datastream module 132 receives features data from the application server 120. Features data can include a variety of data or metadata related to users, accounts, applications, or other input related to driver variables.

The driver variables may be represented by nodes of a causal DAG generated by the DAG generator 134 based on correlations between driver variables. The features data can be used as input nodes of the causal DAG. The features are grouped by driver variables for which the features are associated. Input parameters for the features are provided to the DAG at the nodes for which associated features are grouped. The DAG is provided to the tensorflow solver 136 which solves a system of equations for the tensorflow model.

In various embodiments, an algorithmic sum of a loss function for a result variable of the tensorflow model and a hyperparameter for the DAG is optimized using a deep learning framework for the causal architecture of the driver variables and associated features. This deep learning optimization results in values for a distribution of weightings for the features. The intervention module 142 receives the hyperparameter and identifies features for which a result variable has a high sensitivity. The sensitivity detector may include a perturbation module for detecting sensitivities in response to a perturbation of input parameters.

Various features may be determined by the feature identifier 138 to have sensitivity above a threshold. Identification of the features may be received by the application server 120. The identified features can be used by the application server in a variety of ways. For example, a feature may be provided or presented via a client interface, or another type of intervention may be provided or presented, based on an identified sensitivity of a state change represented by a result variable of the DAG representation to the feature.

In some embodiments, an identified feature may be provided to the intervention module 142. If a state change is desired for a user and the user has not been presented the feature, the feature may be presented in this way to the user to increase the likelihood of the desired state change. Alternatively, if a state change is not desired for a user, a client interface can be precluded from including a feature having high sensitivity.

In various contexts, applications 125 may interface with client devices 110 in various ways to present features. For example, features may be presented via a graphical user interface on a display of a client device. The interface for presenting the feature via an intervention can be generated by the intervention module 142 or an identified feature can be passed to the application server 120 for altering a user interface associated with one or more applications 125 of the server 120. Presenting a feature may include, without limitation, generating a trial offer, generating a change in price or new price, changing a graphical user interface element, changing an account status, generating a custom offer, generating a custom content object, generating an account object, changing an access level, etc. Presenting a feature may also include, adding, removing, or changing an intervention, intervention plan, other treatment plan, or the like.

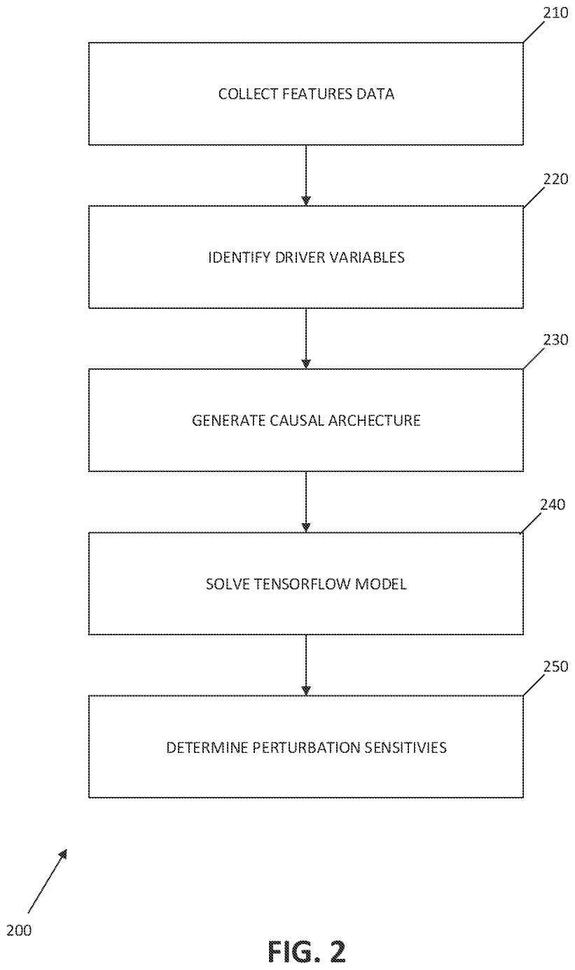

FIG. 2 illustrates an example workflow 200 in which sensitivities of driver variables to user actions using residuals of tensorflow models are determined, according to various embodiments of the present disclosure. In FIG. 2, the workflow begins at step 210 where features data is received. In various examples, features data can be collected from client devices, application servers, applications, databases, and/or data sources.

Next, the workflow 200 may proceed to step 220 where driver variables are identified. In general, driver variables are variables tending to cause, or are correlated with, a particular result variable. In some cases, the result variable may be associated with a state change in a user state or client state, such as ownership of or access to a product or service. Driver variables may be interrelated, so that a particular driver variable tends to cause or is correlated with other driver variables. Driver variables may tend to cause or may be correlated with more than one variable, such as by being correlated with another driver variable and with a result variable.

The workflow 200 next proceeds to step 230 where a causal architecture is generated. Nodes representing the driver variables may be added to a causal architecture with directed edges weighted according to causational correlation between connected nodes. The edges and nodes may be added to a DAG. A result variable may be represented by an end or leaf node of the DAG. This causal DAG allows for the driver variables to be modeled as a tensorflow model.

The workflow 200 next proceeds to step 240 where the tensorflow model is solved. A hyperparameter is defined based on the weights of the features and a loss function of the tensorflow model. A solution for optimization of the hyperparameter is determined by minimizing an algorithmic combination of the weights as components of the hyperparameter and a loss function of the tensorflow model.

The workflow 200 may then proceed to step 250 where perturbation sensitivities are determined. In various embodiments, changes to an input parameter at a node related to a feature may be identified as having a high perturbation sensitivity. Using deep learning frameworks for causal tensorflow models, sensitivities of a result variable to any one feature can be determined by the sensitivity of the hyperparameter to perturbations of the input parameters for the feature. The hyperparameter is used to determine input parameters related to features of the driver variables for which a result variable has a high sensitivity. Once perturbation sensitivities are determined, features can be identified and/or grouped based on sensitivity thresholds. For result variables, features may be presented to a client device according to sensitivity of the result variables, so that features with the highest associated sensitivity can be presented or not presented to a client device to increase or decrease the likelihood of a result variable as outcome.

### Example Causal DAG

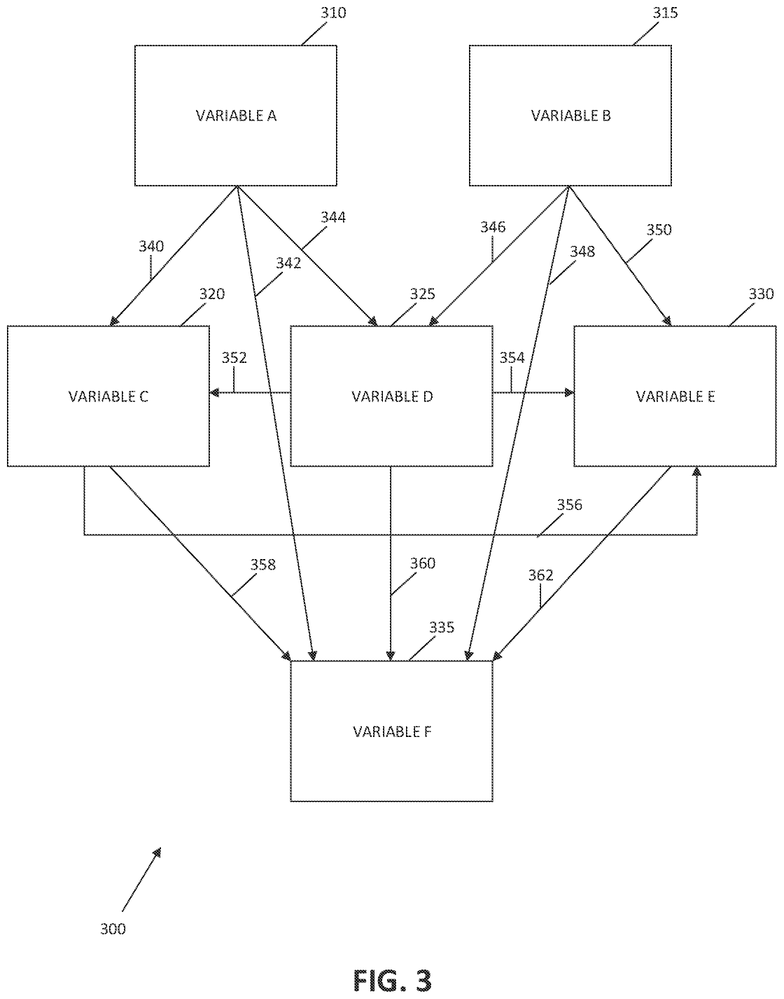

FIG. 3 illustrates an example causal DAG 300 in which a sensitivity of a result variable to a feature of a driver variable is determined, such as by using residuals of a tensorflow model of the DAG, according to various embodiments of the present disclosure.

In the example of FIG. 3, the DAG 300 includes a plurality of nodes 301 and edges 302. The nodes 301 may each be related to a respective variable. In FIG. 3, the plurality of nodes 301 includes Node A 310 representing driver variable A, Node B 315 representing driver variable B, Node C 320 representing driver variable C, Node D 325 representing driver variable D, and Node E 330 representing driver variable E. However, more or fewer driver variables for the DAG 300 may be present in various other embodiments.

In FIG. 3, the DAG 300 includes a Node F 335 representing a result variable F, such as representing various state changes. As shown, the result variable F 335 is an end node of the DAG 300. However, it is noted that a driver variable can also be a result variable for another driver variable, and a result variable can be a driver variable for another result variable, etc. as different scopes of views of a graph representation. In some cases, a DAG may include a plurality of result variables. In general, any number of variables of a tensorflow model may be represented by nodes in a causal DAG, and the nodes may take as input upstream node output and/or other input parameters for each node input at respective nodes.

As shown, Node A 310 is connected to Node C 320 along outgoing edge 340, to Node F 335 along outgoing edge 342, and to Node D 325 along outgoing edge 344. Node B 315 is connected to Node D 325 along outgoing edge 346, to Node F 335 along outgoing edge 348 and to Node E 330 along outgoing edge 350. Node C 320 is connected to Node E 330 along outgoing edge 356 and to Node F 335 along outgoing edge 358. Node D 325 is connected to Node C along outgoing edge 352, to Node E 330 along outgoing edge 354, and to Node F 335 along outgoing edge 360. Node E 330 is connected to Node F 335 along outgoing edge 362. In this example, Node F may represent a result variable, and Nodes A, B, C, D, and E represent driver variables for the result variable.

In a causal DAG representation, a sensitivity for each respective driver variable can be determined, such as for driver variables A, B, C, D, and E of FIG. 3. For variables that are furthest upstream in the causal representation, input parameters can be fed into the nodes. In the example, input parameters may be fed into Node A 310 and Node B 315. To isolate the sensitivity of the result variable to any particular driver variable from upstream variables, a residualization process can be used as follows:

For nodes without upstream nodes, the input parameters can be fed directly into the nodes as part of a first layer. In the example, Node A 310 and Node B 315 may be fed input parameters as part of a first layer. However, more or less nodes may also be fed input parameters as part of a first layer.

For nodes with upstream nodes, the output from upstream nodes can be fed forward into these nodes as part of a secondary layer. An initialized weight for these nodes is used to feed forward input from upstream nodes as part of a secondary layer. For each of these nodes, the first output for the node is negated (i.e. multiplied by −1) and then input parameters for the node are fed into that node. The negated first output and input parameters are used to generate a second output which is fed forward to one or more downstream nodes. The downstream nodes may accept the forward-fed input and respective input parameters for the downstream nodes.

In the example of FIG. 3, Node C 320, Node D 325, and Node E 330 may be part of a secondary layer. However, more or less nodes may also be fed output from upstream nodes as part of a secondary layer. Also, nodes in a secondary layer may also feed output forward to downstream nodes or receive input fed forward from other nodes in a secondary layer. A DAG representation can have any number of secondary layers.

In FIG. 3, Node F 335 receives as input the output from Node A 310, Node B 315, Node C, 320, Node D 325, and Node E 330. In certain embodiments, Node F 335 receives an output from each respective node that has been residualized for any upstream nodes for the respective node. A loss function may be defined according to this value. A hyperparameter may be defined as an algorithmic combination of weights for outgoing edges for each node, such as for Node A 310, Node B 315, Node C, 320, Node D 325, and Node E 330 in the example. An optimization process, such as minimizing an algorithmic sum of a loss function for the output of Node F 335 and the hyperparameter can be performed to determine weights of the Nodes, and/or associated features, as components of the hyperparameter. In general, the hyperparameter can include weights associated with any number of features.

It is noted that the DAG 300 is constructed using an architecture that is exemplary in nature. In some cases, nodes 301 and/or edges 302 can be added to or removed from the DAG 300. In various embodiments, greater or fewer driver variables may be identified as well as greater or fewer correlations, and a causal DAG therefore may have a different number or configuration of nodes and/or edges corresponding to the driver variables and their correlative and/or causational relationships.

### Example Method of Determining Feature Sensitivity

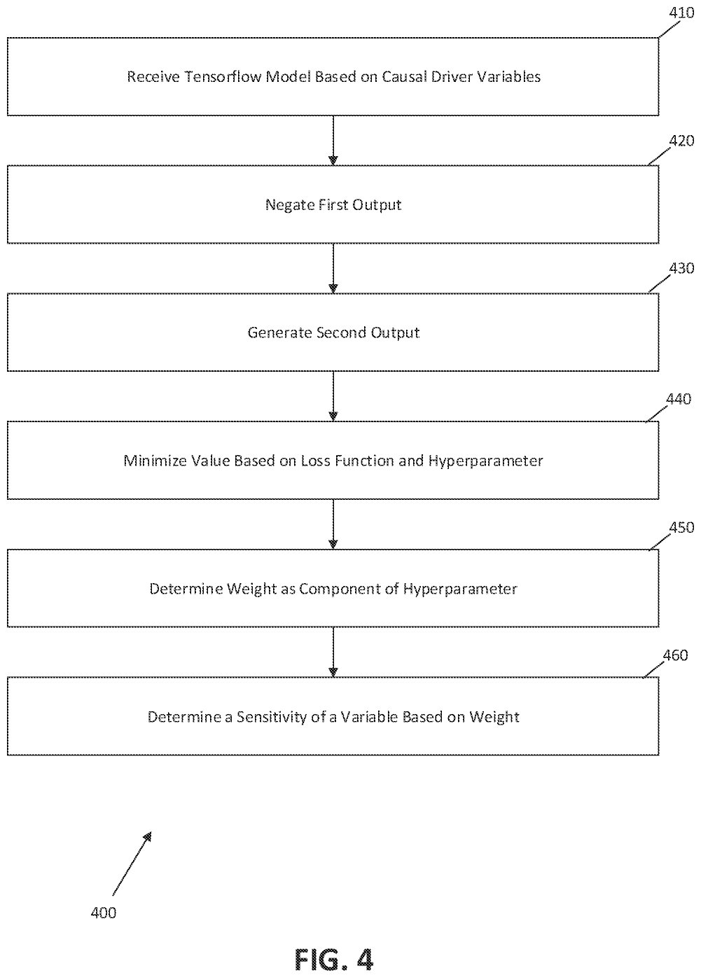

FIG. 4 illustrates an example method for determining sensitivities of result variables to driver variable features, such as by optimizing a hyperparameter using residuals of a tensorflow model of a DAG of the driver variables, according to various embodiments.

In FIG. 4, the method 400 begins at stage 410 where a tensorflow model is received. For example, a tensorflow model may be generated based on causal driver variables of a causal DAG representation. In various contexts, features of a system may be associated with causal driver variables leading to a particular result variable. The nodes can accept as input a set of input parameters representing different features associated with the driver variable represented by the nodes. Weights may be applied for the variable, or a weight for a driver variable may be a multi-dimensional value used to represent a separate weight for each feature of the driver variable.

In embodiments, the respective driver variables each have one or more features associated with the respective driver variables. Input parameters for the features of the driver variables can be separately provided at the nodes representing the driver variables with which the features are associated. A residual value may be calculated by feeding the output of upstream nodes to downstream nodes, determining a first output at the downstream nodes using an initial weight for the nodes, negating the first output, and using the negated first output with input parameters as output to be received as input for downstream nodes. In this way, input received by the result node will be a residualized value determined by a negated first output of secondary nodes in the graph representation.

The method 400 may proceed to stage 420 where a first output is negated. In certain embodiments, a node of the DAG may receive input from an upstream node and/or from a set of input parameters used as input. The input may be used with an initial weighting for the node to determine a first result as a first output. This first result value may then be negated to determine a first negated output. The first negated output may be as input at the node to determine a second output.

In various embodiments, the weights may be initialized to determine the initial weighting. In some cases, input data from which the input parameters are determined can be used to initialize a weight for each feature. For example, input parameters for each feature of a node representing a driver variable in a DAG can be input at the node for the features associated with that driver variable. Next, the method 400 continues at stage 430 where a second output for the node is calculated. The negated first output and input parameters for the node are fed into the node to determine a second output based on the negated first output and the input parameters. The second output may be fed forward to downstream nodes.

The method 400 then proceeds to stage 440 where a value based on a loss function and a hyperparameter is minimized to determine a weight. For example, minimization of an algorithmic sum of a loss function and a hyperparameter having feature weights as components of the hyperparameter can be performed using a deep learning framework to result in a solution for the hyperparameter provided weights as components. The solution for the hyperparameter defines weights for the features that are components of the hyperparameter. Thus weights for features can be determined by the deep learning framework solution for the minimized sum.

The method 400 may then proceed to stage 450 where a weight is determined. The weight may be an updated weight for a node determined by a residualized value for the node output at the result node. In some cases, different input parameters can be used, and updated weights for all the nodes representing driver variables may be determined. In embodiments, sensitivities to any features can be detected by determining high weights above a threshold, high weight perturbation magnitudes above a threshold, or anomalies in weights for features.

The method 400 may then proceed to stage 460 where a sensitivity of a variable to a feature is determined based the weight. For example, a sensitivity of a result variable to a driver variable, or to a feature of a driver variable, can be determined based on an updated value of a weight for a node determined as a component of the hyperparameter. Once features having associated high sensitivity are determined, one or more actions may be performed based on the high sensitivity. In some cases, a feature for which a state change has a high sensitivity for certain users may be presented to a user via a user interface based on a determination that the user is associated with such features for which a state change or other result variable has a high sensitivity. Once the one or more actions are performed, the method 400 may conclude.

In embodiments, different actions can be defined for users whose aggregate features indicate the users are above one or more different sensitivity thresholds. Different actions may be selected according to sensitivity level in this way. For example, a first discount percentage could be offered, or a first dosage level administered for a user of a first sensitivity degree, and a second discount or dosage for a user of a second sensitivity degree, and so forth. Thus, method 400 may improve systems by reducing wasted computing resources associated with generating interfaces and/or interventions that are not useful for achieving an intended result, and may further reduce the time or number of steps needed for a user to receive an interface or intervention which provides a benefit to the user. In some cases, the method 400 may be used to make a selection based on a sensitivity threshold or rank, enabling more precise targeting and better use of resources needed for intervention. Where resources available to be offered to users are limited, more precise targeting can result in greater benefit than otherwise possible with the same resources.

### Example Features Data Set

To compute sensitivity of a particular variable, features of the system can be divided into several types having a directed correlative relationship. The data set may include feature data for various features. The features may each be related to a feature type. Various feature types which may be included in a feature data set are described below. In the example, the data set may be generated for a period of time, such as daily, weekly, monthly, or a longer or shorter period of time. Various other features data associated with, for example, demographic features, product or application state features, pricing features, engagement features, user account features, and the like. The features may be collected periodically to maximize a signal to noise ratio.

Pricing features may include monthly billing, averages over several horizons (months, quarters, years, or longer or shorter periods of time), and differences (and percentages of differences) in billing amounts over these horizons of time. In general, there may be 10-100, or more or less pricing features.

Engagement features may include, by way of non-limiting example: account features related to a number of accounts created in a number of days; audit features related to a number of users, bills, invoices, customers, vendors, money-in transactions, or money-out transactions in a number of days; clickstream features related to a number of clicks, an average time spent at a location, a maximum time spent at a location, a number of different location views, such as within an application; customers features related to a number of customer accounts in time period or within a recent time period; employee features related to a number of employee accounts in time period or within a recent time period; product features related to a count of product feature use or other product features; transaction details, including transaction headers, which may be aggregated; users created and associated permissions; company status or other features; and/or connections to other applications. A time period for the engagement features may be a week, a month, a year, a period in between such time periods, or a longer or shorter time period.

Demographic features may include, but are not limited to, zip-code/geo-location of the company, postal code, region, county, industry and sector description, revenue, and/or company size.

Features may also include product state or state change features. For example, state may be defined as a representation of the combination of products that each user access to, represented as an encoded vector where each dimension of the vector represents a product n of N total products. An index of “1” may indicate a user owns or may access a product or product feature, and an index of ‘0” may indicate that a user does not own or may not access a product or product feature. A state change in the vector represents whether a user has changed ownership or access to a product. In some cases, the data may be updated periodically using a period associated with a membership term length, such as monthly.

### Example Causal Model Formulation

Using the example configuration of FIG. 3, in which there are five driver variables and a result variable, in one example causal model formulation, the driver variable A may be a company profile variable, the driver variable B may be a pricing variable, driver variable C may be an engagement variable, driver variable D may be a state variable, driver variable E may be a price change variable, and result variable F may be a state change variable. In this example, company profile is causationally correlated to engagement, state change, state, and price change. Pricing is causationally correlated to state, state change, and price change. Engagement is causationally correlated to state change and price change. State is causationally correlated to engagement, state change, and price change. Price change is causationally correlated to state change. In this example, a first variable being causationally correlated to another variable means that the first variable tends to cause the other variable.

However, it is noted that various other causal model formulations may be used for various other DAG representations. For example, driver variable A may be a client biometrics variable, the driver variable B may be an intervention dosage plan variable, driver variable C may be a medical history variable, driver variable D may be an effectiveness or state of the medical history, driver variable E may be a dosage change variable, and result variable F may be a change in whether a dosage is effective. In general, a DAG representation may represent any number of variables.

Various causal frameworks may be used in different contexts. Examples of which include gradient boosting frameworks using tree-based learning algorithms as well as convolutional deep neural networks:

Light gradient-boosting machine (“LightGBM”) is a gradient boosting framework that uses tree-based learning algorithms. LightGBM is designed is distributed and efficient with the following advantages: Leaf-wise tree growth: LightGBM chooses the leaf with maximum delta loss to grow and does not have to grow the whole level (level wise growth); Histogram or bin way of splitting: In histogram way of splitting, each continuous feature is bucketed into discrete bins. In this case, to compute the an optimal split iteration over a number of bins rather than a number of points can be performed; and/or Gradient bases one sided sampling (“GOSS”): In GOSS, data instances with different gradients play different roles in the computation of information gain, the instances with larger gradients will contribute more to the information gain. So to retain the accuracy of the information, GOSS keeps the instances with large gradients and randomly drops the instances with small gradients.

Bayesian Optimization: Bayesian approaches can be used to keep track of past evaluation results. These results may be used to form a probabilistic model mapping hyperparameters to a probability of a score on an objective function generated from the results: P(score|hyperparameters). In contrast to random search or grid search methods, this enables past results to be accounted for without having to perform operations over an entire range of a potentially large number of estimators.

In tree-based models, observations associated with many nodes may be clustered together due to having a same propensity score. In some cases, too many data points cluster together when using a lower sensitivity percentile group. To overcome this problem, a causal deep neural network model-based approach may be applied. This enables isolation of the effects of any one or more variables other than a target variable in determining the effect on or sensitivity of a result variable to the target variable. For example, sensitivity of a result based on price or intervention plan. To address limitations of tree-based models and Bayesian Optimization when applied in this way, such a causal model may be constructed as follows:

To remove the effect of dependent variables in the final model output, instead of sending raw feature values, residual values are sent instead downstream in the model to compute a propensity score.

Let Z be dependent on X. So Z can be written as

$${Z}_{i} = f ( {X}_{i} ) + {ϵ}_{i} and ϵ ∼ N ( 0 , {σ}^{2} ) \\ {R}_{i} = {Z}_{i} - {\hat{Z}}_{i} = {Z}_{i} - \hat{f} ( {X}_{i} )$$

So, here Rᵢ is assumes to be independent of Xᵢ and of Rⱼ. To achieve this an additional constraint is imposed on covariance between the residuals, and is implemented as a soft margin constraint that is added to the loss function.

cov(Rᵢ,Rⱼ)→(0&Rᵢ)→0

Therefore, instead of using Zᵢ, in this case Rᵢ is carried forward to the successive steps in the graph.

p=ƒ(X,Xₚ);Xₚ→Xₚ′;p′=ƒ(X,Xₚ′)

Price or intervention plan sensitivity(ps)=p′−p

In the case of price sensitivity, sensitivity may be defined as the change in a user's propensity to churn/upgrade when pricing variables are perturbed:

$$p = f ( {X}_{pricing} , {X}_{engagement ,} {X}_{companyprofile} , {X}_{state} ) \\ {X}_{p}^{′} = {X}_{p} \times ( 1 + d ) \\ {p}^{′} = f ( {X}_{pricing}^{′} , {X}_{engagement} , {X}_{c ompanyprofile} , {X}_{state} ) \\ sensitivity ( ps ) = {p}^{′} - p$$

Thus, a formulation of the above network is written below using example features for company profile, pricing, engagement, and state.

$${X}_{DNB} + {X}_{pricing} \to {S}_{t} : {R}_{{S}_{t}} = {S}_{t} - E ( {S}_{t} \vert {X}_{DNB} + {X}_{pricing} ) \\ {X}_{DNB} + {R}_{{S}_{t}} \to {X}_{ENG} : {R}_{ENG} = {X}_{ENG} - E ( {X}_{ENG} \vert {X}_{DNB} + {R}_{{S}_{t}} ) \\ {X}_{DNB} + {X}_{pricing} + {R}_{{S}_{t}} + {R}_{ENG} \to Δ {X}_{pricing} \\ R Δ {X}_{pricing} = Δ {X}_{pricing} - E ( Δ {X}_{pricing} \vert {X}_{DNB} + {X}_{pricing} + {R}_{{S}_{t}} + {R}_{ENG} ) \\ {X}_{DNB} + {X}_{pricing} + R Δ {X}_{pricing} + {R}_{{OIPF}_{t}} + {R}_{{S}_{t}} \to R Δ {S}_{t}$$

X_{DNB}: Company profile features
X_{pricing}: Pricing features
Sₜ: State of users at time t
X_{ENG}: Engagement of features
ΔX_{pricing}: Features related to pricing change
ΔSₜ: Change in state

These equations define a model which may be implemented using deep learning network by using more than one hidden layer to capture non-linear relationships between variables, an example of which is below.

### Example Deep Learning Framework

In various embodiments, weights (W) for features for which a driver variable has a sensitivity to may be used in a deep learning framework. In an example framework, weights are updated using backpropagation sequentially with respect to labels for a particular state change (i.e. churn or upgrade). In some implementations the framework may use binary cross entropy loss and/or an Adam optimizer. In such or similar frameworks, the correlation between all pairs of residuals can be summed up and added to the loss function with a constant multiplier which is optimized as the hyperparameter. This process allows the weights W to be defined as components of the hyperparameter by optimizing the hyperparameter using the deep learning framework. Sensitivities to features are then determined according to weights respectively associated with the features and defined by the result of applying the deep learning framework. An example framework is presented below:

$$= sigmoid ( {W}_{s 3} ( tanh ( {W}_{s 2} ( tanh ( {W}_{s 1} ( {X}_{DNB} + {X}_{pricing} ) ) ) ) ) ) \\ {R}_{{S}_{t}} = {S}_{t} - \\ {\hat{X}}_{ENG} = sigmoid ( {W}_{E 3} ( tanh ( {W}_{E 2} ( tanh ( {W}_{E 1} ( {X}_{DNB} + {R}_{{S}_{t}} ) ) ) ) ) ) \\ {R}_{ENG} = {X}_{ENG} - {\hat{X}}_{ENG} \\ {p r i c i n g}_{} = sigmoid ( {W}_{dp 3} ( tanh ( {W}_{dp 2} ( tanh ( {W}_{dp 1} ( {X}_{DNB} + {X}_{pricing} + {R}_{{S}_{t}} + {R}_{ENG} ) ) ) ) ) ) \\ {R}_{ENG} = {X}_{ENG} - {\hat{X}}_{ENG} \\ \hat{p} = sigmoid ( {W}_{f 3} ( tanh ( {W}_{f 2} ( tanh ( {W}_{f 1} ( {X}_{DNB} + {X}_{pricing} + R Δ {X}_{pricing} + {R}_{{OIPF}_{t}} + {R}_{{S}_{t}} ) ) ) ) ) )$$

### Example System for Determining Sensitivities to Driver Variable Features Using Residuals

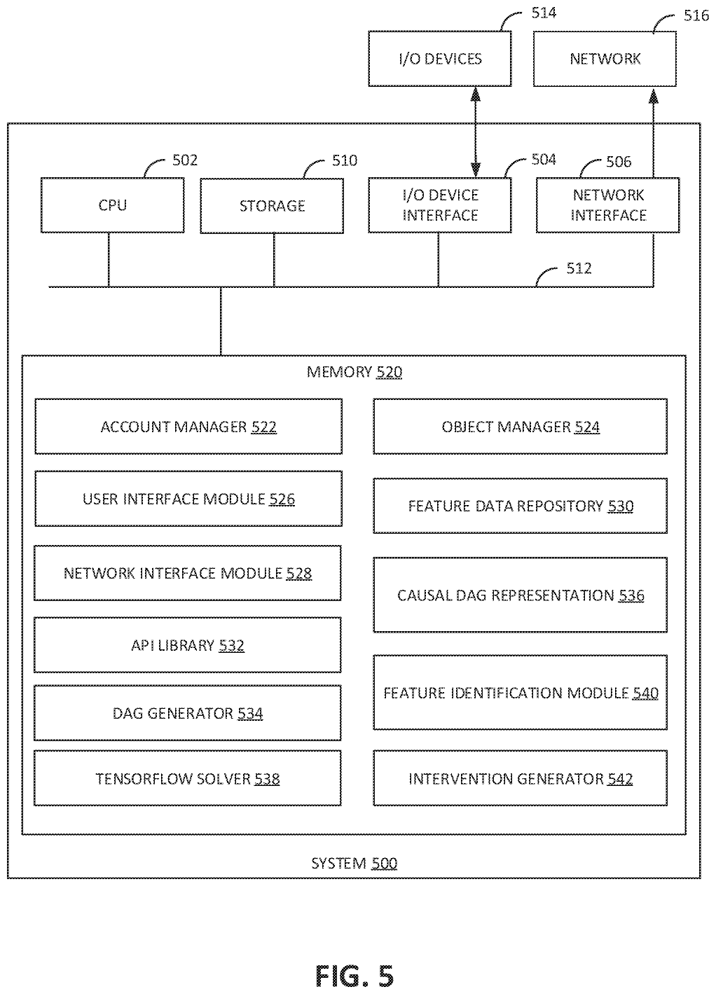

FIG. 5 illustrates an example system configured to determine sensitivities of result variables to driver variable features using residuals of tensorflow models, according to various embodiments of the present disclosure

As shown, system 500 includes a central processing unit (“CPU”) 502, one or more I/O device interfaces 504 that may allow for the connection of various input and/or output (“I/O”) devices 514 (e.g., keyboards, displays, mouse devices, pen input, etc.) to the system 500, network interface 506 through which system 500 is connected to network 516 (which may be a local network, an intranet, the internet, or any other group of computing devices communicatively connected to each other), a memory 520, storage 510, and an interconnect 512. In embodiments, the I/O devices 514 and/or network interface 506 may be used to receive a query in a natural language utterance output a response to the query generated based on extracting operators and operands from the natural language utterance and using the operators and/or operands to determine or define an input parameter for a node of a causal DAG.

CPU 502 may retrieve and execute programming instructions stored in the memory 520 and/or storage 510. Similarly, the CPU 502 may retrieve and store application data residing in the memory 520 and/or storage 510. The interconnect 512 transmits programming instructions and application data, among the CPU 502, I/O device interface 504, network interface 506, memory 520, and/or storage 510. CPU 502 is included to be representative of a single CPU, multiple CPUs, a single CPU having multiple processing cores, and the like.

Memory 520 is representative of a volatile memory, such as a random access memory, or a nonvolatile memory, such as nonvolatile random access memory, phase change random access memory, or the like. As shown, memory 520 includes an account manager 522, an object manager 524, a user interface module 526, a network interface module 528, a feature data repository 530 an application programming interface (“API”) library 532, a datastream module 532, a DAG generator 534, a tensorflow solver 536, a feature identification module 538, a feature handler 540, and an interface generator 540.

In various embodiments, the account manager 522 sends, receives, stores, changes, or otherwise manages account information, which may be associated with particular user. The account manager be suitable for executing operations related to account creation and for managing access, privileges, and/or rights associated with accounts, including payment, ownership, or renting of products or other objects.

In embodiments, the object manager 524 sends, receives, stores, changes, or otherwise manages object information, which may be associated with particular data objects used by the system. Data objects may be associated with one or more accounts. Data object can include tokens, licenses, and various products or other data objects that may be owned by or otherwise associated with an account and/or otherwise used by the system 500.

In the example, the user interface module 526 facilitates a client, user, or administrator using or accessing the system via one or more user interfaces, such as to update or manage the system, or perform operations on or with the system, etc., Likewise, the network interface module 528 facilitates a client, user, or administrator using or accessing the system via one or more network interfaces. Data associated with a user, client, object and/or account, etc., including client engagement data with features of the system, can be recorded in feature data repository 530. The API library 532 may include code or rules for interfacing between applications, such as for recording clickstream data of an application or other client data in the feature data repository 530. The API library 532 may contain information which facilitates the system interfacing with various applications, such as various applications accessed by a client device via an application server. In various embodiments, the API library 532 includes functions for performing operations to record or parse an input stream of data, such as clickstream data, keyboard data, other user input data, application data, application metadata, and/or the like, into features data for driver variable features.

In FIG. 5, the DAG generator 534 constructs a causal DAG representation 536 by applying nodes and edges according to a causal architecture of driver variables and by placing the nodes and edges in a graph representation. The tensorflow solver 538 uses a deep learning framework to solve and/or optimize a hyperparameter of the DAG representation 536. The deep learning framework is built using a causal architecture for features data, such as which may be present in the repository 530 or which may be received via an API, I/O device interface, or network interface. The deep learning framework performs operations to solve a series of equations resulting in an optimized hyperparameter. The hyperparameter includes weights associated with the features and is optimized using an algorithmic combination including a loss function for a result variable and the hyperparameter. This may be used to identify features having high sensitivity, such as features for which a weight above a threshold is used as a corresponding component of the hyperparameter.

In various embodiments, the tensorflow solver 538 determines features having a high sensitivity according to a sensitivity score, threshold, rank, etc. being substantial or significant, such as by being above average or greater than some number of standard deviations from an average.

In the example, the feature handler 540 performs one or more actions in response to a feature being identified by the tensorflow solver 538. In embodiments, the feature or a related feature may be presented via a user interface. In other embodiments, identification of the feature may be provided to an application server. As another example, the feature may be sent to an account or other address, administered via an intervention, or otherwise presented. The feature handler may determine whether an intervention will occur for a feature and identify the feature for the intervention generator 542.

In some embodiments, the intervention generator 542 generates interventions or otherwise alters a user experience or interface in response to a sensitive feature being for a user. For example, if it is determined that a user has interacted with high-sensitivity features or is otherwise a high-sensitivity user, a user interface presenting a customized option for users having that sensitivity to the user can be generated, such as from a template or using a language model. In this way, custom intervention plans or custom price offers may be presented to users based on a user sensitivity determined in part based on a user interacting with a feature for which a high sensitivity has been determined by a high weight for the solution generated by the tensorflow solver 538. As an example, the intervention generator 542 may be used to determine a price for a custom plurality of applications or features of applications of an application server and/or to present the offer to a user. As another example, the intervention generator may be used to determine an intervention plan including one or interventions having a dosage amount and/or dosage time. As another example, the intervention generator may be used to recommend an item based on a high sensitivity for a desired output. In another example the intervention generator may also be used to prevent an item from being recommended based on a high sensitivity to decrease the likelihood of an unwanted output resulting from the sensitivity. Thus, various use cases may be within the scope of this disclosure.

### ADDITIONAL CONSIDERATIONS

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of using machine learning to automatically predict sensitivity of results to features, comprising:
receiving a tensorflow model of a first node, a second node, and a third node downstream from the second node;
negating a first output of the second node determined using an initial output of the first node and an initial weight associated with the second node;
generating a second output of the second node based on the negated first output and a set of input parameters used as input for the second node;
minimizing a value based on a machine learning loss function for the third node to determine a parameter and an updated weight for the second node as a component of the parameter; and
determining a sensitivity of a variable represented by the third node to a feature of the second node based on the updated weight and a threshold.

2. The method of claim 1, further comprising initializing the initial weight according to a cost associated with the second node in the tensorflow model determined based on an initial data set.

3. The method of claim 1, comprising:
defining a first constraint between the first node and the second node and second constraint between the second node and the third node, and
minimizing the value for the loss function by minimizing a first value for a first residual for the first constraint and a second value for a second residual for the second constraint.

4. The method of claim 3, wherein:
the constraint is a first constraint of a plurality of constraints; and
minimizing the value based on the machine learning loss function comprises minimizing an output of the third node for each constraint of the plurality of constraints.

5. The method of claim 3, wherein minimizing the loss function based on the constraint comprises minimizing a sum of absolute values of a plurality of residuals between driver variables of the second node and of covariances between the driver variables.

6. The method of claim 1, wherein:
the second node is a first secondary node of a plurality of secondary nodes; and the method further comprises defining the value based on a plurality of sums of residual outputs and loss functions for the plurality of secondary nodes.

7. The method of claim 1, further comprising selecting the parameters from: a product history, a product price, account information, or clickstream data.

8. The method of claim 1, further comprising determining, based on the output of the third node, at least one of: a churn propensity, an upgrade propensity, a product propensity, and a selection propensity, or a dosage sensitivity.

9. A system comprising a computing device having a processor and a memory having executable instructions stored thereon, which, when executed, perform a method of predicting sensitivity by causing the processor to:
receive a tensorflow model of a first node, a second node, and a third node downstream from the second node;
negate a first output of the second node determined using an initial output of the first node and an initial weight associated with the second node;
generate a second output of the second node based on the negated first output and a set of input parameters used as input for the second node;
minimize a value based on a machine learning loss function for the third node to determine a parameter and an updated weight for the second node as a component of the parameter; and
determine a sensitivity of a variable represented by the third node to a feature of the second node based on the updated weight and a threshold.

10. The system of claim 9, wherein the executable instructions further cause the processor to initialize the initial weight according to a cost associated with the second node in the tensorflow model determined based on an initial data set.

11. The system of claim 9, wherein the executable instructions further cause the processor to:
define a first constraint between the first node and the second node and second constraint between the second node and the third node, and
minimize the value for the loss function by minimizing a first value for a first residual for the first constraint and a second value for a second residual for the second constraint.

12. The system of claim 11, wherein:
the constraint is a first constraint of a plurality of constraints, and
the executable instructions further cause the processor to minimize the value by minimizing an output of the third node for each constraint of the plurality of constraints.

13. The system of claim 11, wherein the executable instructions further cause the processor to minimize the loss function based on the constraint by minimizing a sum of absolute values of a plurality of residuals between driver variables of the second node and of covariances between the driver variables.

14. The system of claim 9, wherein:
the second node is a first secondary node of a plurality of secondary nodes; and the executable instructions further cause the processor to define the value based on a plurality of sums of residual outputs and loss functions for the plurality of secondary nodes.

15. The system of claim 9, wherein the executable instructions further cause the processor to select the parameters from: a product history, a product price, account information, or clickstream data.

16. The system of claim 9, wherein the executable instructions further cause the processor to determine, based on the output of the third node, at least one of: a churn propensity, an upgrade propensity, a product propensity, and a selection propensity, or a dosage sensitivity.

17. A non-transitory computer-readable medium comprising instructions that, when executed by one or more processors, perform a method of predicting sensitivity by causing the processor to:
receive a tensorflow model of a first node, a second node, and a third node downstream from the second node;
negate a first output of the second node determined using an initial output of the first node and an initial weight associated with the second node;
generate a second output of the second node based on the negated first output and a set of input parameters used as input for the second node;
minimize a value based on a machine learning loss function for the third node to determine a parameter and an updated weight for the second node as a component of the parameter; and
determine a sensitivity of a variable represented by the third node to a feature of the second node based on the updated weight and a threshold.

18. The non-transitory computer-readable medium of claim 17, wherein the instructions, when executed, further cause the processor to initialize the initial weight according to a cost associated with the second node in the tensorflow model determined based on an initial data set.

19. The non-transitory computer-readable medium of claim 17, wherein the instructions, when executed, further cause the processor to:
define a first constraint between the first node and the second node and second constraint between the second node and the third node, and
minimize the value for the loss function by minimizing a first value for a first residual for the first constraint and a second value for a second residual for the second constraint.

20. The non-transitory computer-readable medium of claim 19, wherein:
the constraint is a first constraint of a plurality of constraints, and
the instructions, when executed, further cause the processor to minimize the value by minimizing an output of the third node for each constraint of the plurality of constraints.
